(19) United States
(12) Patent Application Publication
(10) Pub. No.: US 2025/0376397 A1
(43) Pub. Date: Dec. 11, 2025

(54) INTEGRATION OF MEMBRANE DISTILLATION (MD) AND PRESSURE RETARDED OSMOSIS (PRO) TO TREAT PRODUCED WATER

(71) Applicant: Saudi Arabian Oil Company, Dhahran (SA)

(72) Inventors: Abdulaziz Y. AlAmmar, Dammam (SA); Seung-Hak Choi, Incheon (KR); Yohannes Hilawe, Ras Tanura (SA)

(21) Appl. No.: 18/739,863

(22) Filed: Jun. 11, 2024

(51) Int. Cl. C02F 9/00; B01D 61/00; B01D 61/36; B01D 61/58; C02F 1/00; C02F 1/20; C02F 1/44; C02F 1/52; C02F 101/20; C02F 103/10

(52) U.S. Cl. CPC C02F 9/00; B01D 61/0023; B01D 61/58; B01D 61/0022; B01D 61/364; B01D 61/366; B01D 2313/083; B01D 2313/18; B01D 2313/243; B01D 2313/246; B01D 2317/022; C02F 1/004; C02F 1/20; C02F 1/445; C02F 1/447; C02F 1/52; C02F 2101/203; C02F 2103/10; C02F 2201/005; C02F 2301/043; C02F 2303/10

(57) ABSTRACT

A system and method for treating produced water are provided. An exemplary system includes a membrane distillation (MD) apparatus to separate the produced water into a retentate stream and a permeate stream, wherein the retentate stream includes a high total dissolved solids (TDS), and the permeate stream includes a low TDS. A pressure retarded osmosis (PRO) unit fluidically coupled to the retentate stream, including a pressure booster pump feeding the retentate stream to the retentate side of the PRO membrane, a low TDS stream coupled to the permeate side of the PRO, a PRO retentate stream, and a PRO permeate stream. A turbine is fluidically coupled to the PRO retentate stream, wherein the turbine is mechanically coupled to a generator.

### TECHNICAL FIELD

This disclosure relates to methods of treating produced water using an integrated system including a pressure retarded osmosis unit and a membrane distillation unit.

### BACKGROUND

Produced water (PW), a significant byproduct of oil and gas extraction, poses significant environmental challenges due to its high contaminant content and high volume that in some cases surpassing the volume of oil extracted. PW contains complex mixture of organic and inorganic constitutes such as free and dissolved oil, emulsions, salts, suspended solids, heavy metals and sour gases like hydrogen sulfide. Managing and treating PW is energy-intensive, but necessary as other alternative water resources are limited especially in water-scare regions. Gas Oil Separation Plants (GOSPs) often rely on groundwater for various operations, which include maintaining pressure of reservoirs to enhance oil recovery as well as using it as wash water in desalters.

A desalter is a unit operation in GOSPs where crude oil is washed with water containing a low level, for example, less than about 15,000 mg/L, of total dissolved solids (TDS) to remove salts, minerals, and other impurities. The primary purpose of using a desalter is to prevent corrosion and fouling of downstream equipment by reducing the salt content in the crude oil before refining. In the desalter, water is mixed with the incoming crude oil, usually by a mixing valve. The water, being polar, attracts the water-soluble salts and other impurities from the non-polar crude oil. The resulting mixture then enters a settling tank, where it may be subjected to an electric field, to enhance the coalescence of water droplets which settle at the bottom due to gravity, taking the contaminants with them. The purified crude oil floats to the top and is drawn off for further refining, while the contaminated water at the bottom, termed as “desalter effluent”, is removed and treated before disposal or reuse. Conventional desalination technologies are inadequate for high TDS PW, for example, greater than about 100,000 mg/L. However, the high salinity of PW presents an opportunity to exploit the high osmotic pressure for diluting its contaminants and recovering energy.

### SUMMARY

An embodiment described in examples herein provides a system for treating produced water. The system includes a membrane distillation (MD) apparatus to separate the produced water into a retentate stream and a permeate stream, wherein the retentate stream includes a high total dissolved solids (TDS), and the permeate stream includes a low TDS. A pressure retarded osmosis (PRO) unit fluidically coupled to the retentate stream, including a pressure booster pump feeding the retentate stream to the retentate side of the PRO membrane, a low TDS stream coupled to the permeate side of the PRO, a PRO retentate stream, and a PRO permeate stream. A turbine is fluidically coupled to the PRO retentate stream, wherein the turbine is mechanically coupled to a generator.

Another embodiment described in examples herein provides a method for treating produced water. The method includes pretreating produced water to form a pretreated stream, feeding the pretreated stream to a membrane distillation (MD) apparatus to form a permeate stream and a retentate stream. The pressure of the retentate stream is boosted to the osmotic pressure of a PRO membrane in a pressure retarded osmosis (PRO) apparatus. The retentate stream is fed to a retentate side of the PRO membrane in the PRO apparatus. A low total dissolved solids (TDS) stream is fed to the permeate side of the PRO membrane in the PRO apparatus. A PRO retentate is passed to a turbine. Power is generated in the turbine from the PRO retentate.

### BRIEF DESCRIPTION OF DRAWINGS

FIG. 1 is a schematic drawing of a wellbore, showing increased production of water in a reservoir layer in a subterranean formation.

FIG. 2 is a schematic drawing of an integrated system for processing produced water that integrates a membrane distillation (MD) unit and a pressure retarded osmosis (PRO) unit.

FIG. 3 is a schematic diagram of another integrated system for processing produced water that integrates a membrane distillation (MD) unit and a pressure retarded osmosis (PRO) unit.

FIG. 4 is a schematic drawing of another integrated system for processing produced water that integrates a membrane distillation (MD) unit and a pressure retarded osmosis (PRO) unit.

FIGS. 5A-5D are schematic drawings of a number of configurations that can be used as the MD unit.

FIG. 6 is a schematic drawing of the operation of a pressure retarded osmosis (PRO) unit.

FIG. 7 is a process flow diagram of a method for an integrated membrane distillation unit and a pressure retarded osmosis unit.

### DETAILED DESCRIPTION

In the proposed process, produced water is pretreated to remove mainly free oil, suspended solids, hydrogen sulfide and other contaminants. A membrane distillation (MD) unit is used to concentrate the pretreated produced water. This produces two product streams, a retentate stream with a total dissolved solids (TDS) content that is higher than the produced water, and a permeate stream that is much lower in TDS than the produced water. The permeate stream can be at least partially used as the wash water to desalt crude oil in a desalter and as a source of utility water in a Gas Oil Separation Plants (GOSP).

The desalter effluent and the concentrated produced water in the retentate stream from MD unit are fed to a pressure retarded osmosis (PRO) unit as feed and draw solutions, respectively. Water naturally permeates through membranes from the more dilute desalter effluent into the concentrated produced water due to osmosis. The flow of water increases the volume on the concentrated produced water side, which can be used to drive a turbine, thereby generating energy. Finally, the diluted produced water is further treated to meet injection requirements for pressure maintenance in reservoirs, for example, by reducing the concentration of dissolved O₂, dissolved CO₂, iron, suspended solids, oil, and the like. Accordingly, the techniques described herein can eliminate the consumption of groundwater in GOSPs and enable reusing the diluted produced water for pressure maintenance while adding energy to the grid.

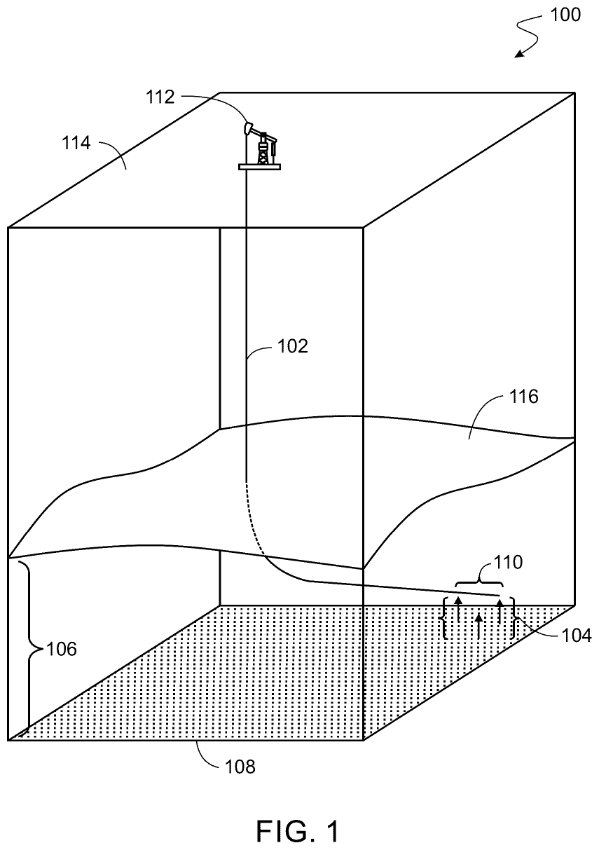

FIG. 1 is a schematic drawing 100 of a wellbore 102, showing increased production of water 104 in a reservoir layer 106 in a subterranean formation. The water 104 may come from an underlying water table, or water layer 108, below the reservoir layer 106. A section 110 of the wellbore 102 closest to the water layer 108 may draw water 104 into the wellbore 102 during the pumping cycle of a pump jack 112 at the surface 114, increasing the amount of produced water.

In other circumstances, a continuous production from the reservoir layer 106 to the surface 114 may entrain water 104 from the water layer 108, increasing the amount of water 104 produced from the section 110 of the wellbore. Further, as the reservoir layer 106 is produced, the amount of hydrocarbons between the water layer 108 and a cap rock layer 116 decreases, which may allow the water layer 108 to draw closer to the cap rock layer 116, moving closer to the section 110 of the wellbore 102. This may also increase the amount of water 104 produced.

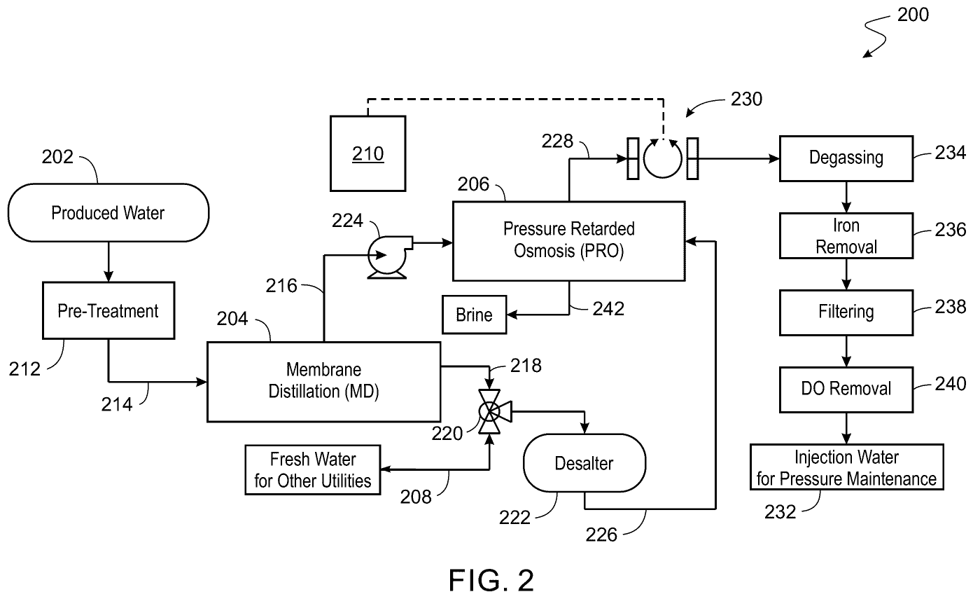

FIG. 2 is a schematic drawing of an integrated system 200 for processing produced water 202 that integrates a membrane distillation (MD) unit 204 and a pressure retarded osmosis (PRO) unit 206. The integrated system 200 produces purified water 218 and energy 210, for example, electrical power for the utilities.

The produced water (PW) 202 is passed through a pretreatment unit 212 to remove contaminants that may damage membranes and meet injection requirements, such as oil and suspended solids. Primarily, pretreatment targets the removal of dissolved hydrocarbon, H₂S, and suspended solids. For example, the process can be combination of the follow unit operations. The pretreatment unit 212 can include corrugated plate interceptors (CPI) to remove low-density free oil and suspended solids by using the specific gravity difference. Further, a gas flotation process, such as induced gas flotation (IGF) or dissolved gas flotation (DGF) can be used to remove emulsified oil and suspended solids using chemical and gas. In gas flotation, an inert gas such as nitrogen can be used. The pretreatment unit 212 can use filters such as nutshell filters, multimedia filters, or cartridge filters to remove oily residues and suspended solids. Activated carbon can be used in the unit to remove oily residue. Physical separation processes, such as cyclones, coagulants, and flocculants can be used in the pretreatment unit 212 to remove oil. Coagulants and flocculants can be used with pH control agents. The pretreatment process can also include the injection of scale inhibitors and biocides.

The units used in the pretreatment process depend on reservoir different specifications are required. For example, having a total suspended solids (TSS) of less than about 5 ppm, a pH of between about 6.6 and about 7.3, an H₂S content of less than about 0.5 ppm or about 0 ppm, an O₂ content of less than 10 ppb. Further, mineral content is limited by the injection water. For example, a barium content of less than about 1 ppm, a zinc content of less than about 1 ppm, an iron content of less than about 1 ppm, a strontium content of less than about 30 ppm, sulfate: less than 900.

Some of these limits can be met in the pre-treatment stage and some of these limits which cannot influence membrane performance can be controlled in the post-treatment stage. For instance, dissolved oxygen does not influence membrane performance. Therefore, O₂ can be removed before or after MD and PRO. However, H₂S, oil or TSS can influence the membrane performance. Therefore, H₂S, oil and TSS are removed before MD and PRO, which simplifies post-treatment.

The pre-treated PW 214 meets the inlet feed requirements of the membrane in the MD unit 204. For example, a maximum oil-in-water content of less than 20 ppm, a maximum total oil and suspended solids (TSS) of less than 50 ppm, a mean particle size of suspended solid of less than about 5 microns, and an H₂S concentration of less than about 1 ppm, or 0 ppm. The temperature of the pre-treated PW 214 feed to the membrane is less than about 45° C.

The pretreated PW 214 is fed to the MD unit 204. A retentate stream 216 from the MD unit 204 is concentrated in total dissolved solids (TDS), for example, greater than 200,000 mg/L of TDS. A permeate stream 218 from the MD unit 204 is substantially purified water 208, for example, with a TDS concentration of less than 2,000 mg/L. A valve 220 can be used to select the flow of the purified water of the permeate stream 218 to a desalter 222, such as in a gas oil separation plant (GOSP). In some embodiments, depending on the quantity (or volume) of water produced from MD 204, fresh water may be supplied from plant (or facility) to meet wash water volume through 208. If the volume of permeate stream 218 is more than what the wash water needs of the GOSP, the extra water can be supplied to facility. In the desalter, the purified water removes salt from a crude oil stream.

The concentrated PW of the retentate stream 216 is boosted in pressure by a pump 224 then fed to the PRO unit 206 as a draw solution. In this embodiment, the effluent 226 from the desalter 222 is fed to the PRO unit 206 as a feed solution, for example, having a relatively low TDS of less than 15,000 mg/L.

In the PRO unit 206, the difference in TDS between the draw solution and the feed solution creates an osmotic pressure differential that causes water to permeate across the membrane of the PRO unit 206 from the feed solution to the draw solution. This increases the volume of the draw solution, which is the PRO retentate 228. The PRO retentate 228 is converted into energy 210, for example, by being passed through a hydro-turbine 230 or other pressure recovery device.

The valve 220 can be adjusted to allow at least a portion of the purified water 208 from the MD unit 204 to be used for other utilities, for example, within the GOSP or other processing units. As described above, if the volume of the permeate stream 218 is not sufficient to meet wash water volume, purified water can be supplied from the facility and mixed with the permeate stream 218, and then feed to the desalter.

After passing through the hydro-turbine 230, the PRO retentate 228 from the post-treatment steps can be used for injection water 232. Depending on the reservoir requirement and the ionic impurities, the PRO retentate 228 can be treated to meet standards for the injection water 232. For example, the PRO retentate 228 can be passed through a degassing unit 234 to remove most dissolved gases. An iron removal unit 236 can remove iron ions, for example, by the addition of chelating agents to force precipitation. A filtering unit 238 can remove solids, for example, formed in the iron removal unit 236 or present in the PRO retentate 228. A dissolved oxygen (DO) removal unit 240 can remove dissolved oxygen from the PRO retentate 228, forming the injection water 232.

The purified water 208 can be treated to meet applicable quality standards for reuse within the facility as utility water. The feed solution to the PRO unit 206 is increased in TDS concentration as water migrates across the membrane to the draw solution. Accordingly, the PRO permeate stream 242 forms a brine solution which can be disposed of or blended with the PRO retentate 228 for use as the injection water 232.

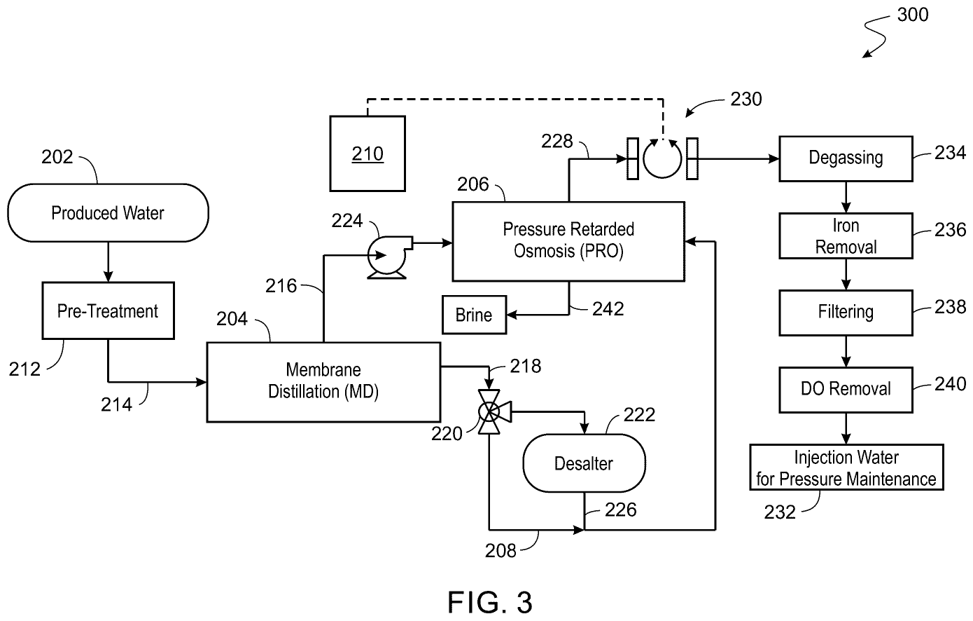

FIG. 3 is a schematic diagram of another integrated system 300 for processing produced water 202 that integrates a membrane distillation (MD) unit 204 and a pressure retarded osmosis (PRO) unit 206. Like numbered items are as described with respect to FIG. 2. In this embodiment, the valve 220 is configured to allow at least a portion of the purified water 208 to bypass the desalter 222. This increases the concentration difference of the feed solution and draw solution to the PRO unit 206, which increases the osmotic pressure across the membrane in the PRO unit 206. As a result, the volume of the PRO retentate 228 is increased, which increases the energy 210 generated. Further, the desalter effluent 226 can be mixed with the purified water 208.

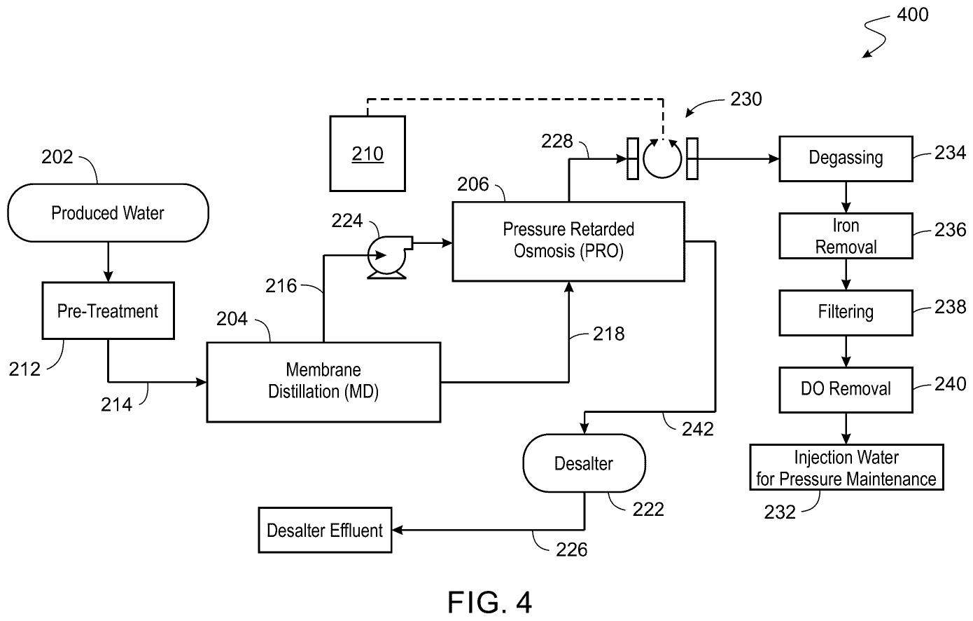

FIG. 4 is a schematic drawing of another integrated system 400 for processing produced water 202 that integrates a membrane distillation (MD) unit 204 and a pressure retarded osmosis (PRO) unit 206. Like numbered items are as described with respect to FIG. 2. In this embodiment, the purified water of the permeate stream 218 is provided to the PRO unit 206 to function as a feed solution. This maximizes the difference in the TDS between the feed solution and the draw solution relative to the configurations of FIGS. 2 and 3. Accordingly, this also provides the highest osmotic pressure and thus the highest volume for the PRO retentate 228, which maximizes the generation of energy 210. The PRO permeate stream 242 is then used as a wash water for the desalter 222. The desalter effluent 226 can then be discarded. Depending on the TDS of the desalter effluent 226, it may be recycled, at least in part, by being combined with the produced water 202.

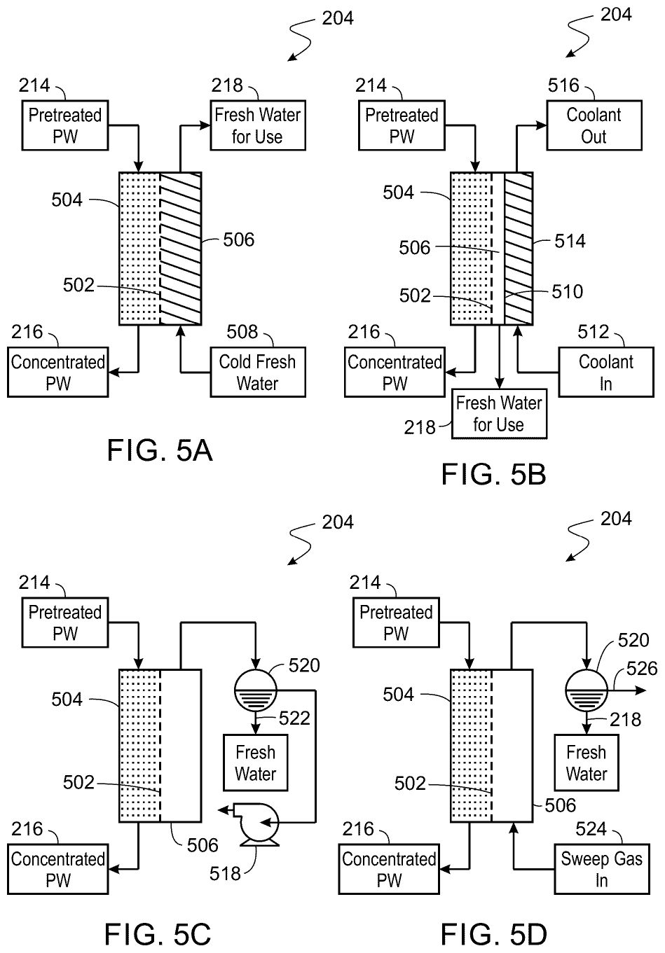

FIGS. 5A-5D are schematic drawings of a number of configurations that can be used as the MD unit 204. Like numbered items are as described with respect to FIG. 2. Membrane distillation is a thermal desalination technology that utilizes a hydrophobic membrane 502 to separate hot, saline feed water in a retentate compartment 504 and cold, distilled water in a permeate compartment 506. The temperature difference across the hydrophobic membrane 502 causes water vapor to pass from the hot retentate compartment 504 to the cold permeate compartment 506, leaving the salts and impurities behind, thus producing purified water.

FIG. 5A is a schematic drawing of a direct contact membrane distillation (DCMD) unit. In DCMD, the hot feed, which is the pre-treated PW 214 is fed to the retentate compartment 504, and the cold distillate is on the permeate compartment 506. The retentate compartment 504 and the permeate compartment 506 are in direct contact with opposite sides of the hydrophobic membrane 502. To drive vapor transport across the membrane, a temperature gradient is created by heating the pre-treated PW 214 and cooling a stream of fresh water 508, which is fed to the permeate compartment 506. Accordingly, the permeate stream 218 is increased in volume over the cooled stream of fresh water 508 from the water removed from the pre-treated PW 214. A retentate stream 216 of concentrated produced water is also formed.

FIG. 5B is a schematic drawing of an air gap membrane distillation (AGMD) unit. In AGMD, the permeate compartment 506 is an air gap that is placed between the hydrophobic membrane 502 and a condensation surface 510. As in DCMD, the pre-treated PW 214 is heated before introduction into the retentate compartment 504. Water vapor passes through the hydrophobic membrane 502 and then crosses the air gap of the before condensing on the condensation surface 510, which is cooled by the introduction of a coolant stream 512. The coolant flows through a cooling compartment 514 that is thermally coupled to the condensation surface 510. A warmed coolant stream 516 then exits the cooling compartment 514. The coolant can then be chilled and returned to the cooling compartment 514. In some embodiments, the coolant is chilled water, for example, the fresh water of the permeate stream 218 can be chilled and used as the coolant. This configuration can reduce heat losses and improve condensation efficiency compared to the DCMD unit described with respect to FIG. 5A.

FIG. 5C is a schematic drawing of a vacuum membrane distillation (VMD) Unit. In VMD, a vacuum is applied to the permeate compartment 506 on the distillate side of the membrane by a vacuum pump or blower 518. This lowers the vapor pressure of the water, enhancing the driving force for mass transfer across the hydrophobic membrane 502. Accordingly, the produced water vapor is drawn through the hydrophobic membrane 502 by the vacuum and is condensed in a condenser 520, providing fresh water 522. As described with respect to FIGS. 5A and 5B, the pre-treated PW 214 can be heated to further increase mass transfer across the hydrophobic membrane 502.

FIG. 5D is a schematic drawing of a sweeping gas membrane distillation (SGMD) unit. In SGMD, a sweep gas stream 524 is flowed through the permeate compartment 506 to aid in the removal of the water vapor from the membrane surface to a condenser 520. For example, a high partial pressure of water vapor in the permeate compartment 506 is maintained by introducing gases that do not contain water vapor. This induces water vapor diffusion through hydrophobic membrane. This can improve mass transfer and increase flux over the configuration of FIG. 5A. As for the prior configurations, the pre-treated PW 214 can be heated to further increase mass transfer across the hydrophobic membrane 502.

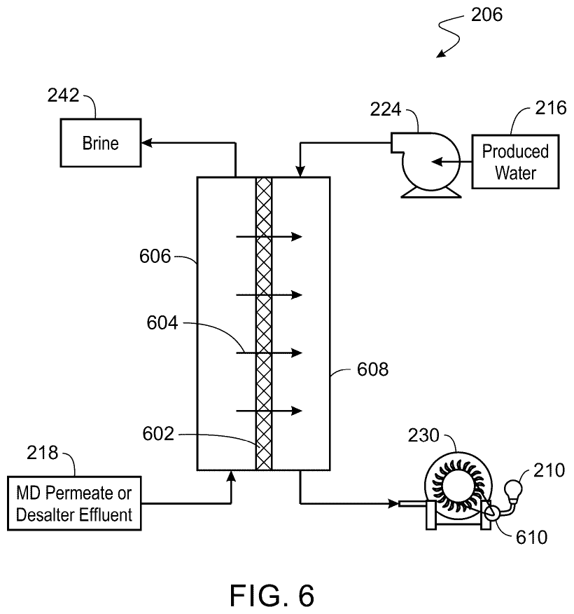

FIG. 6 is a schematic drawing of a pressure retarded osmosis (PRO) unit 206. PRO is a process that generates energy from an osmotic pressure differential across a semi-permeable membrane 602. Like numbered items are as described with respect to FIG. 2. The osmotic pressure differential is between a fresh water or low TDS level water, for example, a desalter effluent and fresh water or mixture of both, and a high TDS water, such as a concentrated produced water stream. In this method, water 604 from low TDS solution in a PRO permeate chamber 606 passes through the semi-permeable membrane 602 towards a higher TDS solution in a PRO retentate compartment 608. The osmotic pressure difference between the two solutions is then used to extract energy 210, typically by spinning a hydro-turbine 230 connected to a generator 610.

The process is called retarded because pressure is applied to the PRO retentate compartment 608 by the pump 224, slowing down the osmotic flow of fresh water, but preventing any reverse flow. The applied pressure is less than the osmotic pressure difference between the two solutions. The efficiency of PRO depends on the material and module configuration of the semi-permeable membrane, which should allow only water molecules to pass through while blocking salt and other impurities. It is worth mention that PRO can be integrated with other renewable energy sources. For example, solar or wind energy can be used to power the pumps that apply hydraulic pressure to the retentate compartment 608 (the draw side) of the PRO unit 206, making the overall process more sustainable. The theoretical maximum energy that can be extracted by the PRO unit can be estimated based on the Gibbs free energy of mixing (Eq. 1), accounting the osmotic pressure difference between two solutions of different salinities and assuming ideal conditions.

As a comparative example, a PRO unit 206 utilizing a concentrated produced water from an MD unit 204 with a TDS of 240,000 mg/L as the draw solution and a desalter effluent as a feed solution with a TDS of 38,000 mg/L can generate a maximum theoretical energy of 3.882 kWh/m³. A similar PRO unit 206 can generate a maximum theoretical energy of 4.105 kWh/m³ if the MD permeate (fresh water) used as feed solution with a lower TDS of 2,000 mg/L. Table 1 summarizes the effect of salinity of the draw and feed solution on the theoretical producible power per cubic meter of draw solution.

$$- \frac{Δ {G}_{mix}}{iRT} = \frac{{C}_{Mix}}{θ} ln ( {γ}_{Mix} {C}_{Mix} ) - {C}_{Feed} ln ( {γ}_{Feed} {C}_{Feed} ) - \frac{1 - θ}{θ} {C}_{Draw} ln ( {γ}_{Draw} {C}_{Draw} ) \qquad Eq . 1$$

Gₘᵢₓ: molar Gibbs free energy of mixing
i: species designation in solution
R: gas constant
T: absolute temperature
θ: ratio of total moles of the solution to total moles of the system or mixture
C_{Mix}: molar concentration of species i in mixture
C_{Feed}: molar concentration of species i in feed solution
C_{Draw}: molar concentration of species i in draw solution
Y_{Mix}: activity coefficient of species i in mixture
Y_{Feed}: activity coefficient of species i in feed solution
Y_{Draw}: activity coefficient of species i in draw solution

TABLE 1
Various combination of draw-feed salinity and
recoverable theoretical energy using PRO.

| Draw solution | | | Feed solution | | | Calculated energy |
|---|---|---|---|---|---|---|
| (type & ppm) | | | (type & ppm) | | | (kWh/m³) |
| Seawater | 35,000 | ppm | River water | 100 | ppm | 0.607 |
| SWRO brine | 77,000 | ppm | River water | 100 | ppm | 1.318 |
| Produced water | 100,000 | ppm | River water | 100 | ppm | 1.761 |
| Produced water | 200,000 | ppm | River water | 100 | ppm | 3.536 |
| Produced water | 200,000 | ppm | Seawater | 35,000 | ppm | 3.135 |
| Produced water | 240,000 | ppm | Seawater | 45,000 | ppm | 3.989 |
| Produced water | 240,000 | ppm | Desalter effluent | 38,000 | ppm | 3.882 |
| Produced water | 240,000 | ppm | MD permeate | 2,000 | ppm | 4.105 |

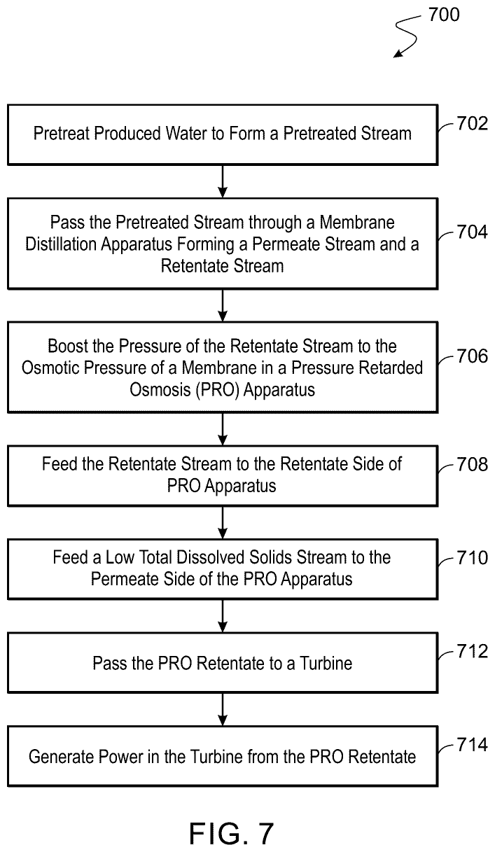

FIG. 7 is a process flow diagram of a method 700 for an integrated membrane distillation unit and a pressure retarded osmosis unit. The method begins at block 702, when a produced water stream is pretreated to form a pretreated stream. At block 704, the pretreated stream is passed through a membrane distillation (MD) apparatus, forming a permeate stream and a retentate stream.

At block 706, the pressure of the retentate stream is boosted to the osmotic pressure of a membrane in a pressure retarded osmosis (PRO) apparatus. At block 708, the retentate stream is fed to the retentate side of a PRO apparatus as a draw solution.

At block 710, a low total dissolved solids (TDS) stream is fed to the permeate side of the PRO apparatus as a feed solution. As described with respect to FIGS. 2-4, the low TDS stream may be a stream from a desalter in a gas oil separation plant (GOSP), the permeate stream from the MD apparatus, or a combination thereof.

At block 712, the PRO retentate is fed to a hydro-turbine, or other pressure to energy recovery device. At block 714, power is generated from the PRO retentate, for example, by a generator mechanically coupled to the hydro-turbine.

An embodiment described in examples herein provides a system for treating produced water. The system includes a membrane distillation (MD) apparatus to separate the produced water into a retentate stream and a permeate stream, wherein the retentate stream includes a high total dissolved solids (TDS), and the permeate stream includes a low TDS. A pressure retarded osmosis (PRO) unit fluidically coupled to the retentate stream, including a pressure booster pump feeding the retentate stream to the retentate side of the PRO membrane, a low TDS stream coupled to the permeate side of the PRO, a PRO retentate stream, and a PRO permeate stream. A turbine is fluidically coupled to the PRO retentate stream, wherein the turbine is mechanically coupled to a generator.

In an aspect, the system includes a desalter fluidically coupled to the permeate stream, wherein an outlet stream from the desalter is fluidically coupled to the permeate side of the PRO.

In an aspect, the system includes a valve fluidically coupled between the MD apparatus and the desalter, wherein the valve is coupled to a freshwater store to allow fresh water to be added to the permeate stream.

In an aspect, the system includes a valve fluidically coupled between the MD apparatus and the desalter, wherein the valve is coupled to a freshwater store to allow fresh water from the MD apparatus to be diverted for other uses. In an aspect, the system includes a valve fluidically coupled between the MD apparatus in the desalter, wherein the valve is coupled to a bypass line around the desalter.

In an aspect, combinable with any other aspect, the system includes a degassing unit fluidically coupled to an outlet stream from the turbine. In an aspect, an iron removal unit coupled to an outlet stream from the degassing unit. In an aspect, the system includes a filter coupled to an outlet stream from the iron removal unit. In an aspect, the system includes a dissolved oxygen removal unit coupled to an outlet stream from the filter.

In an aspect, combinable with any other aspect, the MD apparatus includes a direct contact membrane distillation (DCMD) apparatus.

In an aspect, combinable with any other aspect, the MD apparatus includes an air gap membrane distillation (AGMD) apparatus.

In an aspect, combinable with any other aspect, the MD apparatus includes a vacuum membrane distillation (VMD) apparatus.

In an aspect, combinable with any other aspect, the MD apparatus includes a sweeping gas membrane distillation (SGMD) apparatus.

Another embodiment described in examples herein provides a method for treating produced water. The method includes pretreating produced water to form a pretreated stream, feeding the pretreated stream to a membrane distillation (MD) apparatus to form a permeate stream and a retentate stream. The pressure of the retentate stream is boosted to the osmotic pressure of a PRO membrane in a pressure retarded osmosis (PRO) apparatus. The retentate stream is fed to a retentate side of the PRO membrane in the PRO apparatus. A low total dissolved solids (TDS) stream is fed to the permeate side of the PRO membrane in the PRO apparatus. A PRO retentate is passed to a turbine. Power is generated in the turbine from the PRO retentate.

In an aspect, the method includes feeding the retentate stream from the MD apparatus to a desalter.

In an aspect, the method includes bypassing the desalter to feed the retentate stream to the permeate side of the PRO.

In an aspect, the method includes feeding an outlet stream from the desalter to the permeate side of the PRO.

In an aspect, the method includes feeding the retentate stream from the MD apparatus to the permeate side of the PRO.

In an aspect, the method includes treating the PRO retentate from an outlet of the turbine to form an injection water.

In an aspect, the method includes feeding the PRO retentate to the desalter. Other implementations are also within the scope of the following claims.

What is claimed is:

1. A system for treating produced water, comprising:
a membrane distillation (MD) apparatus to separate the produced water into a retentate stream and a permeate stream, wherein the retentate stream comprises a high total dissolved solids (TDS), and the permeate stream comprises a low TDS;
a pressure retarded osmosis (PRO) unit fluidically coupled to the retentate stream, comprising:
a pressure booster pump feeding the retentate stream to the retentate side of the PRO membrane;
a low TDS stream coupled to the permeate side of the PRO;
a PRO retentate stream; and
a PRO permeate stream;
a turbine fluidically coupled to the PRO retentate stream, wherein the turbine is mechanically coupled to a generator.

2. The system of claim 1, comprising a desalter fluidically coupled to the permeate stream, wherein an outlet stream from the desalter is fluidically coupled to the permeate side of the PRO.

3. The system of claim 2, comprising a valve fluidically coupled between the MD apparatus and the desalter, wherein the valve is coupled to a freshwater store to allow fresh water to be added to the permeate stream.

4. The system of claim 2, comprising a valve fluidically coupled between the MD apparatus and the desalter, wherein the valve is coupled to a freshwater store to allow fresh water from the MD apparatus to be diverted for other uses.

5. The system of claim 2, comprising a valve fluidically coupled between the MD apparatus in the desalter, wherein the valve is coupled to a bypass line around the desalter.

6. The system of claim 1, comprising a degassing unit fluidically coupled to an outlet stream from the turbine.

7. The system of claim 6, comprising an iron removal unit coupled to an outlet stream from the degassing unit.

8. The system of claim 7, comprising a filter coupled to an outlet stream from the iron removal unit.

9. The system of claim 8, comprising a dissolved oxygen removal unit coupled to an outlet stream from the filter.

10. The system of claim 1, wherein the MD apparatus comprises a direct contact membrane distillation (DCMD) apparatus.

11. The system of claim 1, wherein the MD apparatus comprises an air gap membrane distillation (AGMD) apparatus.

12. The system of claim 1, wherein the MD apparatus comprises a vacuum membrane distillation (VMD) apparatus.

13. The system of claim 1, wherein the MD apparatus comprises a sweeping gas membrane distillation (SGMD) apparatus.

14. A method for treating produced water, comprising:
pretreating produced water to form a pretreated stream;
feeding the pretreated stream to a membrane distillation (MD) apparatus to form a permeate stream and a retentate stream;
boosting the pressure of the retentate stream to the osmotic pressure of a PRO membrane in a pressure retarded osmosis (PRO) apparatus;
feeding the retentate stream to a retentate side of the PRO membrane in the PRO apparatus;
feeding a low total dissolved solids (TDS) stream to the permeate side of the PRO membrane in the PRO apparatus;
passing a PRO retentate to a turbine; and
generating power in the turbine from the PRO retentate.

15. The method of claim 14, comprising feeding the retentate stream from the MD apparatus to a desalter.

16. The method of claim 15, comprising bypassing the desalter to feed the retentate stream to the permeate side of the PRO.

17. The method of claim 14, comprising feeding an outlet stream from the desalter to the permeate side of the PRO.

18. The method of claim 14, comprising feeding the retentate stream from the MD apparatus to the permeate side of the PRO.

19. The method of claim 14, comprising treating the PRO retentate from an outlet of the turbine to form an injection water.

20. The method of claim 14, comprising feeding the PRO retentate to the desalter.
